(19) United States
(12) Patent Application Publication
(10) Pub. No.: US 2017/0215437 A1
(43) Pub. Date: Aug. 3, 2017

(54) SYSTEM AND METHOD FOR FORMING WAFER BLOCKS

(71) Applicant: HAAS FOOD EQUIPMENT GMBH, WIEN (AT)

(72) Inventors: MICHAEL DOLKOWSKI, BADEN (AT); JOHANNES HAAS, WIEN (AT); JOSEF HAAS, LEOBENDORF (AT); STEFAN JIRASCHEK, KOENIGSBRUNN (AT); FLORIAN KREINER, ALTENWOERTH (AT); JUERGEN REITHNER, SCHOENBERG AM KAMP (AT)

(21) Appl. No.: 15/305,363

(22) PCT Filed: Apr. 28, 2015
(86) PCT No.: PCT/EP2015/059147

§ 371 Date: Oct. 20, 2016

(30) Foreign Application Priority Data
Apr. 29, 2014 (AT) A311/2014

(51) Int. Cl. A21D 13/45; A21C 14/00; A21C 15/00

(52) U.S. Cl. CPC A21D 13/45; A21C 15/002; A21C 14/00

(57) ABSTRACT

A system and a method for forming wafer blocks. The wafer blocks include at least three wafer sheets and at least two cream layers of two different creams. The wafer sheets and the cream layers are arranged alternately and lying parallel upon one another.

The invention relates to a system and a method for forming wafer blocks, where the wafer blocks comprise at least three wafer sheets and at least two cream layers made of two different creams, where the wafer sheets and the cream layers are disposed alternately and lying parallel upon another.

In particular, the invention relates to a system in which wafer blocks are produced as intermediate products to produce wafer products such as, for example, slices.

Apparatuses for forming wafer blocks have been known for a long time and published in various embodiments.

For example, systems are known in which wafer sheets lying edge to edge are coated with a chocolate cream along a rectilinearly running conveying surface. In a further step in order to form a wafer block, a wafer sheet coated with a cream is joined together with an uncoated wafer sheet so that a so-called wafer sandwich is formed. This wafer sandwich comprises a wafer base sheet and a wafer cover sheet and an interposed layer of a cream. Such an apparatus, also designated as sandwich former, is known for example from AT511406A1.

In order to form a multilayer wafer block, now according to the prior art, further coated wafer sheets are fed to a stacking station and brought in contact with the wafer sandwich so that a wafer block having a multilayer structure is formed, which always comprises a wafer cover sheet, a wafer base sheet, intermediate wafer sheets and interposed cream layers. Such an apparatus, also designated as stacking apparatus, is known, for example, from AT511407A1.

Conventional systems are limited, however, in that only a single cream can be used as material for the cream layers. In order to introduce a plurality of different cream layers of different creams into a wafer block, according to the prior art a plurality of coating heads can be provided along the first rectilinearly running conveying surface, where the different coating heads can coat different creams onto a wafer sheet. A disadvantage with this construction is that the coating process cannot be stopped exactly so that this results in a mixing of creams on the wafer sheet. This mixing can be seen on the finished product, whereby these products must be removed from the production process as rejects.

For the efficient coating of wafer sheets, it has proved successful to coat a continuous strip of wafer sheets arranged edge to edge in a row with a coating head. In this case, a continuous, spacing-free coatable surface is formed by the strip-shaped contiguous wafer sheets. Consequently, these wafer sheets can be coated as far as the edge which further improves the efficiency of the method and the system. However, in prior art apparatus for producing wafer blocks this non-stop continuous application of cream is only possible with a single cream.

It is now the object of the invention to overcome the disadvantages of the prior art. In particular it is the object of the invention to provide a system and a method for forming wafer blocks with at least two cream layers of two different creams, the efficiency of which is improved, where at the same time the flexibility of the choice of sequence and the number of layers is given. In particular, it is the object of the invention to provide a system and a method in which the wafer blocks can be produced flexibly with different structure, that is efficiently with a selectable number and selectable sequence of different cream layers.

The object according to the invention is in particular solved by the features of the independent patent claims.

The invention relates in particular to a system for forming wafer blocks wherein the wafer blocks comprise at least three wafer sheets and at least two cream layers of two different creams, wherein the wafer sheets and the cream layers are disposed alternately and lying parallel upon one another, comprising: an input station at which individual wafer sheets, preferably coming from a wafer baking machine, are transferred successively to the system, a first conveying surface for transporting first wafer sheets, wherein in the course of the first conveying surface a first coating station is provided for applying a first cream layer of a first cream to the first wafer sheets, a second conveying surface for transporting second wafer sheets, wherein in the course of the second conveying surface a second coating station is provided for applying a second cream layer of a second cream to the second wafer sheets, a third conveying surface for transporting third wafer sheets, a stacking station at which the first wafer sheets with their first cream layers, the second wafer sheets with their second cream layers and the third wafer sheets are stacked to form one or more wafer blocks, an input switch arrangement by means of which the wafer sheets of the input station are transferred as desired to the first conveying surface, to the second conveying surface or to the third conveying surface, and an output switch arrangement by means of which the wafer sheets of the first conveying surface, the second conveying surface or the third conveying surface are transferred as desired to the stacking station.

It is optionally provided that the first conveying surface, the second conveying surface and the third conveying surface are disposed at a distance from one another, adjacent to one another and/or above one another and that the first conveying surface, the second conveying surface and the third conveying surface can be connected to one another by the input switch arrangement and the output switch arrangement so that a wafer sheet coming from the input station can be transported as desired via the first conveying surface, the second conveying surface or the third conveying surface to the stacking station.

It is optionally provided that in the course of the first conveying surface along the first conveying direction, a first feed conveyor device for transporting the first wafer sheets to the first coating station is disposed upstream of the first coating station, that in the course of the first conveying surface along the first conveying direction, a first coating conveyor device for transporting the first wafer sheets in the first coating station is disposed in the region of the first coating station, that in the course of the first conveying surface along the first conveying direction, a first removal conveyor device for transporting the first wafer sheets and the first cream layer applied thereon from the first coating station to the stacking station is disposed downstream of the first coating station and/or that the transporting speed of the first coating conveyor device is lower than the transporting speed of the first feed conveyor device and/or is lower than the transporting speed of the first removal conveyor device, so that the first wafer sheets transported consecutively on the first conveying surface have a shorter distance from one another in the region of the first coating station than in the course of the first conveying surface upstream and/or downstream of the first coating station.

It is optionally provided that in the course of the second conveying surface along the second conveying direction, a second feed conveyor device for transporting the second wafer sheets to the second coating station is disposed upstream of the second coating station, that in the course of the second conveying surface along the second conveying direction, a second coating conveyor device for transporting the second wafer sheets in the second coating station is disposed in the region of the second coating station, that in the course of the second conveying surface along the second conveying direction, a second removal conveyor device for transporting the second wafer sheets and the second cream layer applied thereon from the second coating station to the stacking station is disposed downstream of the second coating station and/or that the transporting speed of the second coating conveyor device is lower than the transporting speed of the second feed conveyor device and/or is lower than the transporting speed of the second removal conveyor device, so that the second wafer sheets transported consecutively on the second conveying surface have a shorter distance from one another in the region of the second coating station than in the course of the second conveying surface upstream and/or downstream of the second coating station.

It is optionally provided that the speed difference between the transporting speed of the feed conveyor device minus the transporting speed of the coating conveyor device substantially corresponds to the value of the dimension of the distance between two wafer sheets conveyed consecutively on the feed conveyor device, so that the wafer sheets in the coating station lie substantially edge to edge and form a continuous, spacing-free coatable surface.

It is optionally provided that the speed difference between the transporting speed in the region of the removal conveyor device minus the transporting speed in the region of the coating conveyor device substantially corresponds to the value of the dimension of the distance between two wafer sheets conveyed consecutively on the removal conveyor device, so that the wafer sheets, which in the coating station lie substantially edge to edge and form a continuous, spacing-free coatable surface, have a distance from one another in the region of the removal conveyor device in order to be conveyed at a distance from one another into the stacking station.

It is optionally provided that a stack conveyor device is provided in the region of the stacking station and that the speed difference between the transporting speed in the region of the stack conveyor device minus the transporting speed in the region of the coating conveyor device substantially corresponds to the value of the dimension of the distance between two wafer sheets conveyed consecutively on the stack conveyor device and coming from a conveying surface.

It is optionally provided that the distance between two wafer sheets conveyed consecutively on the removal conveyor device is greater than the dimension of a wafer sheet in the conveying direction, so that a second wafer sheet of the second conveying surface can be positioned between two first wafer sheets of the first conveying surface by means of the output switch arrangement and/or so that a first wafer sheet of the first conveying surface can be positioned between two second wafer sheets of the second conveying surface by means of the output switch arrangement.

It is optionally provided that the transport of the wafer sheets in the input station, the stacking station and the coating stations takes place continuously and that the coated wafer sheets are transported along the respective conveying surface arranged linearly in a row.

It is optionally provided that the transporting speed of the stack conveyor device is greater than the transporting speed of the coating conveyor device and in particular is greater than or equal to or as the sum of the average transporting speeds of the first conveying surface plus the transporting speeds of the second conveying surface plus the transporting speeds of the third conveying surface so that the wafer sheets are conveyed at a distance from one another into the stacking station.

It is optionally provided that the feed conveyor device, the coating conveyor device, the removal conveyor device and/or the stack conveyor device comprises or comprise one or more band conveyors, one or more belt conveyors, one or more suction belt conveyors or a similar conveying device.

It is optionally provided that the input switch arrangement and/or the output switch arrangement comprises or comprise a switch arrangement such as a pivotable plate, a pivotable band conveyor, a pivotable belt conveyor, a pivotable suction belt conveyor, conveying surfaces inclined with respect to one another and converging in or contrary to the conveying direction, an elevator and/or a positive pressure source for changing the direction of movement and for raising the wafer sheets.

It is optionally provided that the input switch arrangement and/or the output switch arrangement comprises or comprise a plurality of switch arrangements.

It is optionally provided that a first input switch is provided which has a first position in which wafer sheets coming from the input station are transferred to the first conveying surface and which has a second position in which wafer sheets coming from the input station are conveyed to the second conveying surface.

It is optionally provided that a second input switch is provided which has a first position in which wafer sheets coming from the input station and/or from the first input switch are transported further along the second conveying surface and which has a second position in which wafer sheets coming from the input station and/or from the first input switch are transferred to the third conveying surface.

It is optionally provided that a first output switch is provided, which has a first position in which first wafer sheets coming from the first coating station are transferred to the stack conveyor device and which has a second position in which second wafer sheets coming from the second coating station are transferred to the stack conveyor device.

It is optionally provided that the stacking station comprises a spiral stacking device, a drop shaft stacking device or a combination of a sandwiching device and a stacking device.

It is optionally provided that the stacking station comprises a sandwiching device by means of which a first wafer sheet coated with a first cream or a second wafer sheet coated with a second cream is covered with an uncoated third wafer sheet so that a wafer sandwich comprising a wafer base sheet, a wafer cover sheet and an interposed cream layer is formed.

It is optionally provided that a second output switch is provided by means of which the third wafer sheets coming from the third conveying surface are transferred to the stack conveyor device and in particular are transported directly into a sandwiching device in order to be combined there with a first wafer sheet comprising a first cream layer or with a second wafer sheet comprising a second cream layer to form a wafer sandwich.

It is optionally provided that the stacking station comprises a stacking device in which a wafer sandwich comprising at least one coated first wafer sheet and/or comprising at least one coated second wafer sheet is stacked so that a multilayer wafer block is formed.

It is optionally provided that the stacking station comprises a calibrating device or a pressing device in which the wafer blocks and the components thereof are compressed to a predetermined or selectable height.

The invention in particular relates to a method for forming a wafer block which comprises three wafer sheets and at least two cream layers of different creams, wherein the wafer sheets and the cream layers are arranged alternately and lying parallel on one another, comprising the following steps: specifying a desired number and a desired sequence of first wafer sheets each with a first cream layer of a first cream and second wafer sheets each with a second cream layer of a second cream, conveying wafer sheets from the input station to the input switch arrangement, selecting the position of the input switch arrangement so that wafer sheets are transferred as desired to the first conveying surface, to the second conveying surface or to the third conveying surface, applying the first cream layer of a first cream to the first wafer sheet or to the first wafer sheets in the course of the first conveying surface, applying the second cream layer of a second cream to the second wafer sheet or to the second wafer sheets in the course of the second conveying surface, transporting a third wafer sheet along the third conveying surface, transporting the first wafer sheets with a first cream layer, the second wafer sheets with a second cream layer and the third wafer sheets via the output switch arrangement to the stacking station, so that first wafer sheets or sheets with their first cream layer, the second wafer sheet or sheets with their second cream layer and the third wafer sheet are transferred consecutively and in a number and sequence corresponding to the specified desired number and sequence to the stacking station.

The method optionally comprises the following steps: transporting wafer sheets along the course of the first conveying surface or along the second conveying surface consecutively via: a feed conveyor device to a coating conveyor device and further to a removal conveyor device, wherein the wafer sheets in the region of the coating conveyor device have a lower transporting speed than in the region of the feed conveyor device and/or in the region of the removal conveyor device so that the wafer sheets in each case in the region of the feed conveyor device and/or in the region of the removal conveyor device have a larger distance from one another than in the region of the coating conveyor device.

It is optionally provided that the speed difference between the transporting speed in the region of the feed conveyor device minus the transporting speed in the region of the coating conveyor device substantially corresponds to the value of the dimension of the distance between two wafer sheets conveyed consecutively on the feed conveyor device, so that the wafer sheets in the coating station lie substantially edge to edge and form a continuous, spacing-free coatable surface.

It is optionally provided that the speed difference between the transporting speed in the region of the removal conveyor device minus the transporting speed in the region of the coating conveyor device substantially corresponds to the value of the dimension of the distance between two wafer sheets conveyed consecutively on the feed conveyor device, so that the wafer sheets which lie in the coating station substantially edge to edge and form a continuous, spacing-free coatable surface, have a distance from one another in the region of the removal conveyor device in order to be conveyed spaced apart from one another into the stacking station.

It is optionally provided that the speed difference between the transporting speed in the region of the stack conveyor device minus the transporting speed in the region of the coating conveyor device substantially corresponds to the value of the dimension of the distance between two wafer sheets conveyed consecutively on the feed conveyor device and coming from a conveying surface.

It is optionally provided that the distance between two wafer sheets conveyed consecutively on the removal conveyor device is greater than the dimension of a wafer sheet in the conveying direction so that a second wafer sheet of the second conveying surface can be positioned between two first wafer sheets of the first conveying surface by means of the output switch arrangement or so that a first wafer sheet of the first conveying surface can be positioned between two wafer sheets of the second conveying surface.

It is optionally provided that the conveying of the wafer sheets in the input station, the stacking station and the coating stations takes place continuously and that the coated wafer sheets are conveyed along the respective conveying surface arranged linearly in a row.

It is optionally provided that a wafer block having x first wafer sheets and y second wafer sheets and a third wafer sheet is formed so that the wafer block comprises x+y+1 wafer sheets and x+y cream layers.

The system according to the invention and the method according to the invention are adapted to produced wafer blocks. In particular flat wafers having a crispy-brittle consistency are designated as wafers. These are baked in baking tong ovens in lockable baking tongs at high pressure. The end products produced from the wafer blocks are known, for example, as slices or Neapolitan slices.

Preferably wafer blocks having a plurality of cream layers are produced by the method according to the invention on the system according to the invention. In this case, a plurality of different creams can be used. For example, high-fat, sugar-containing coatable masses which can be applied to individual wafer sheets in a coating station are designated as creams. Examples of such creams are chocolate creams, in particular chocolate creams having a light, dark or brown colour. Furthermore, masses such as, for example, lemon creams, nut creams or similar creams or pastes are also suitable for forming a cream layer of the wafer block. Examples for ingredients of suitable creams are fat, sugar, caramel or also additives such as cheese, herbs, flavourings etc.

In the coating station, respectively one cream is applied to a wafer sheet. The application can be made, for example, by fluted rollers. The cream can also be applied to the wafer sheet by a pouring method.

Furthermore, the system according to the invention comprises a plurality of conveying devices. These conveying devices can, for example, be configured as endless conveyors, belt conveyors, band conveyors, suction belt conveyors, conveyors with spiral link belts and/or as similar conveying devices. In particular, the conveying devices are suitable and/or adapted to move wafer sheets, optionally coated wafer sheets along a conveying direction. This movement is accomplished at a certain transporting speed. This transporting speed is preferably controllable by a controller and/or adjustable by means of a regulating device.

The system according to the invention comprises an input station. In the input station, individual wafer sheets which are supplied consecutively, for example by a wafer baking machine are received. The input station can, for example, be configured as an endless conveyor, as a conveyor belt, as a belt conveyor or similar structure.

Furthermore, the system according to the invention comprises an input switch arrangement. The input switch arrangement corresponds to a mechanical switch in the technical sense. This switch makes it possible to divide the wafer sheets coming from the input station onto different conveying surfaces. The input switch arrangement can, for example, contain one or more flap-shaped or pivotable structures such as, for example, a pivotable band conveyor, a pivotable belt conveyor, a plurality of gripping fingers, positive pressure nozzles or a removal drum. Furthermore, the input switch arrangement can be formed from a plurality of switches. The input switch arrangement is in particular adapted to divide wafer sheets coming from the input station onto a plurality of conveying surfaces.

The system preferably comprises a first conveying surface. A first coating station is located in the course of the first conveying surface. This first coating station preferably comprises a cream supply or a cream reservoir. In the coating station the first cream is applied to a first wafer sheet which moves on the first conveying surface.

Furthermore, a second conveying surface is preferably provided. A second coating station is located in the course of the second conveying surface. This second coating station preferably comprises a supply or a reservoir for a second cream. The supply or the reservoir of the second coating station is preferably independent of the supply or the reservoir of the first coating station. Consequently the two coating stations can be loaded with different creams independently of one another. As a result, a second cream can be applied to a second wafer sheet in the second coating station.

A third conveying surface is further preferably provided. Optionally no coating devices or coating stations are provided in the course of the third conveying surface. The third conveying surface is preferably adapted to convey the wafer cover sheet to form a wafer sandwich. Optionally however a third coating station is also provided in the course of the third conveying surface. This third coating station can contain a storage container or a supply for a third cream.

The input switch arrangement is in particular adapted to guide wafer sheets coming from the wafer baking machine and/or the input station as desired to the first conveying surface, the second conveying surface or the third conveying surface.

Furthermore, the system according to the invention preferably comprises an output switch arrangement. This output switch arrangement is suitable and/or adapted to guide wafer sheets coming from the first conveying surface, the second conveying surface or the third conveying surface to the stacking station.

The stacking station is preferably a device or an arrangement of several devices which is adapted to assemble the wafer block components to form a wafer block. In particular, the stacking station comprises a sandwich former as well as a stacking device. In the stacking station all those wafer block components which are supplied to the stacking station along the stack conveyor device are stacked on top of one another in the stacking station. Depending on the position of the output switch arrangement therefore as desired first wafer sheets with a first cream layer, second wafer sheets with a second cream layer or third wafer sheets are supplied consecutively to the stacking station. As a result, an arbitrary structure of the wafer block can be formed.

In order to make the production process as efficient as possible, it is advantageous to maximize the throughput of the system. Usually the throughput of the system is limited by the throughput of the wafer baking machine. Modern wafer baking machines, for example, have a production capacity of about 80 or 60 to 100 wafer sheets per minute. The wafer sheets usually have a size of about 40×80 cm. Consequently, about 60 to 100 wafer sheets per minute are transferred from the wafer baking machine to the input station. These wafer sheets are divided onto the individual conveying surfaces by the input switch arrangement. The wafer sheets, possibly coated, are combined again by the output switch arrangement in order to be transferred to the stacking station. In the stacking station, a throughput which corresponds to the throughput of the wafer baking machine is again required to optimize the production process. This throughput, divided by the number of wafer layers per wafer block, gives the capacity of wafer blocks which can be produced by the systems.

According to the invention, it can be provided that the wafer blocks have a selectable number and sequence of different cream layers. The average speed per conveying surface is adapted depending on the ratio of the different wafer block components. If, for example, twice as many first wafer sheets as second wafer sheets per wafer block need to be stacked, the average speed of the first conveying surface will be twice as high as the speed of the second conveying surface.

The conveying surfaces have conveying devices which can preferably be controlled or regulated independently on one another so that the transporting speeds along the conveying devices can be adjusted or selected flexibly.

Furthermore, the individual conveying surfaces comprise individual conveying devices which can have different speeds and/or which can be controlled or regulated independently of one another. As mentioned initially, in order to improve the efficiency it is advantageous if in the region of the coating station, the wafer sheets are coated lying contiguously edge to edge. To this end a coating conveyor device is provided. On this coating conveyor device, the wafer sheets are conveyed through the coating station or in the region of the coating station.

In the conveying direction upstream of the coating station, a feed conveyor device is provided. Preferably the feed conveyor device has a higher speed than the coating conveyor device. The wafer sheets transferred from the input station to the feed conveyor device are transported at a distance from one another. This means that a distance is provided between two consecutive wafer sheets. In order to now reduce this distance in order to form a continuous coatable surface, the coating conveyor device has a lower transporting speed than the feed conveyor device. As a result, the wafer sheets are pushed together and preferably conveyed edge to edge through the coating station.

Preferably the speed difference between the transporting speed of the feed conveyor device minus the transporting speed of the coating conveyor device is substantially equal to the value of the dimension of the distance between two wafer sheets conveyed one after the other on the feed conveyor device. For example, if two wafer sheets are moved at a speed of one m/s on the feed conveyor device, where the two wafer sheets furthermore have a spacing of ½ m from one another, the coating conveyor device can have a transporting speed of ½ m/s so that both wafer sheets are conveyed edge to edge through the coating station. In the aforesaid calculation it should be noted that the unit of measurement of the distance and the unit of the path per unit time for the transporting speed must have the same unit.

Furthermore, the removal conveyor device preferably has a higher transporting speed than the coating conveyor device. As a result, the individual wafer sheets lying edge to edge are separated again after the coating station on the removal conveyor device. Depending on the speed, the individual coated wafer sheets again have a certain spacing from one another after the coating station. In particular, the individual wafer sheets in the stacking station should have a certain distance from one another so that a simple and clean stacking of the wafer block components is possible. To this end, it would fundamentally also be possible to increase the speed for the purpose of spacing apart the wafer sheets on the stack conveyor device.

Furthermore, the speeds and clock rates of the individual conveyor devices must also be adapted in such a manner that wafer sheets of different conveying surfaces can be combined to form a wafer block.

To this end, preferably congestion zones are provided in which the wafer sheets are transported in a slowed manner and acceleration zones in which wafer sheets are transported more rapidly. As a result, buffer zones are formed which enable the flexible choice of the arrangement, the number and the sequence of wafer block components.

These congestion zones, buffer zones and acceleration zones can be formed by the individual conveying devices. In particular, a plurality of conveying devices can be provided along the different conveying surfaces, the speeds of which can be controlled and/or regulated flexibly.

An exemplary method for producing a wafer block could, for example, comprise the following steps:

In a first step, for example, the number and the sequence of the individual wafer block components can be selected. Depending on the choice, in particular, depending on the ratio of first wafer sheets having a first cream layer to second wafer sheets having a second cream layer, the individual wafer sheets are divided between the individual conveying surfaces. The division of the wafer sheets between the individual conveying surfaces is preferably accomplished in a ratio which corresponds to the different wafer block components in the finished wafer block. The conveying speeds of the individual conveying surfaces and conveyor devices are adapted so that the individual wafer block components can be transferred to the stacking station in the desired ratio, in particular in the desired sequence and the desired number. Furthermore, the wafer block components also have different speeds at different locations in the course of the individual conveying surfaces. For example, the wafer sheets are initially moved slowly in order to have a buffer reservoir of wafer sheets. Optionally the wafer sheets are conveyed slowly in the region of the coating stations so that these preferably lie contiguously edge to edge. Subsequently the wafer sheets can be accelerated in the course of the conveying surfaces after the coating station so that the wafer sheets again have a spacing from one another. This spacing is necessary, for example, in order to enable an alternating transfer by the output switch arrangement from different conveying surfaces. In the stacking station the individual wafer block components should preferably also have a spacing from one another in order to bring about an improvement in the stackability.

The transport speeds of the individual conveying devices are preferably controlled by a control unit. In particular, the individual transport speeds are adapted depending on the choice of the number and sequence of wafer block components of a wafer block.

The system according to the invention preferably comprises switch arrangements. These switch arrangements are suitable and/or adapted to transfer a wafer sheet coming from a conveying surface as desired to various further conveying surfaces. In a simple embodiment, the input switch arrangement, for example, is fitted with a pivotable element such as, for example a pivotable conveyor or a pivotable conveying surface. A further possibility of a switch arrangement is that a first conveying surface is provided from which a second conveying surface branches. The two conveying surfaces are therefore, when viewed in the conveying direction, guided towards one another. Below the first conveying surface or in the region of the first conveying surface, a positive pressure source is provided for delivering a specific air flow. By activating the air flow, a wafer sheet can be raised from the first conveying surface in order to be conducted further to the second conveying surface. This switch arrangement can in particular be provided as an input switch arrangement. Optionally a further conveying surface is provided above the second conveying surface which prevents the wafer sheet moved upwards by the air flow from rising too far from the conveying surfaces. In particular, this further conveying surface projects beyond the second conveying surface contrary to the conveying direction and preferably acts as a guiding surface or stop.

Such a construction can also be provided for transferring a wafer sheet from the second conveying surface to the third conveying surface.

Combining surfaces for example in the conveying direction such as combining plates or combining conveyors can be provided as output switch arrangement.

Optionally a switch arrangement, in particular an input switch arrangement comprises an elevator. This elevator, depicted in FIG. 2, for example, corresponds to an endless conveyor which has a vertical principal direction of extension and on which a plurality of wafer sheets can be conveyed up and down in the vertical direction. This elevator is used, in particular for cooling the hot wafer sheets as discharged from the baking machine. In the region of the first conveying surface or in the region of the second conveying surface, the wafer sheets in the elevator are conveyed downwards and preferably deposited from above onto one of the conveying surfaces. There they are removed from the conveying devices and conveyed further along the conveying device. Optionally the sections of the first conveying surface or the second conveying surface which remove the wafer sheets from the elevator are designed to be movable or pivotable. As a result, the time and the position of the removal of the wafer sheets can be regulated and/or controlled.

For stacking the wafer block components, in particular the first, the second and the third wafer sheets, a stacking station is preferably provided. This stacking station can, for example, be configured as a combination of a sandwiching device with a pressing device. In this design, a wafer sandwich is initially formed in the sandwiching device. This is raised by the stacking device and in particular by a suction plate of the stacking device from the stack conveyor device and subsequently placed on subsequent further wafer sheets provided with a cream layer. When the finished wafer block is formed, this is placed by the stacking device on the stack conveyor device and further transported.

Optionally the stacking station 10 is configured as a spiral stacking device. In this, initially an uncoated wafer sheet, in particular a third wafer sheet, is raised by spiral conveyor devices vertically from the stack conveyor device. Then further wafer sheets provided with a cream layer are placed from below onto the first uncoated wafer sheet. When the finished wafer block is formed, this is removed and preferably pressed together by a calibrating device, in particular a calibrating roller and calibrated.

According to a further embodiment, the stacking station can be configured as a drop shaft. In this, the wafer sheets provided with a cream layer are initially conveyed into the stacking station. Then they are stacked one above the other in a drop shaft so that the desired sequence of wafer sheets coated with cream is obtained. Lastly an uncoated wafer sheet, in particular a third wafer sheet is placed on the existing wafer sheets in order to form the finished wafer block. Then the finished wafer block is preferably calibrated. This calibration is accomplished again by means of a calibrating roller or a press plate.

The invention is now explained further with reference to specific embodiments.

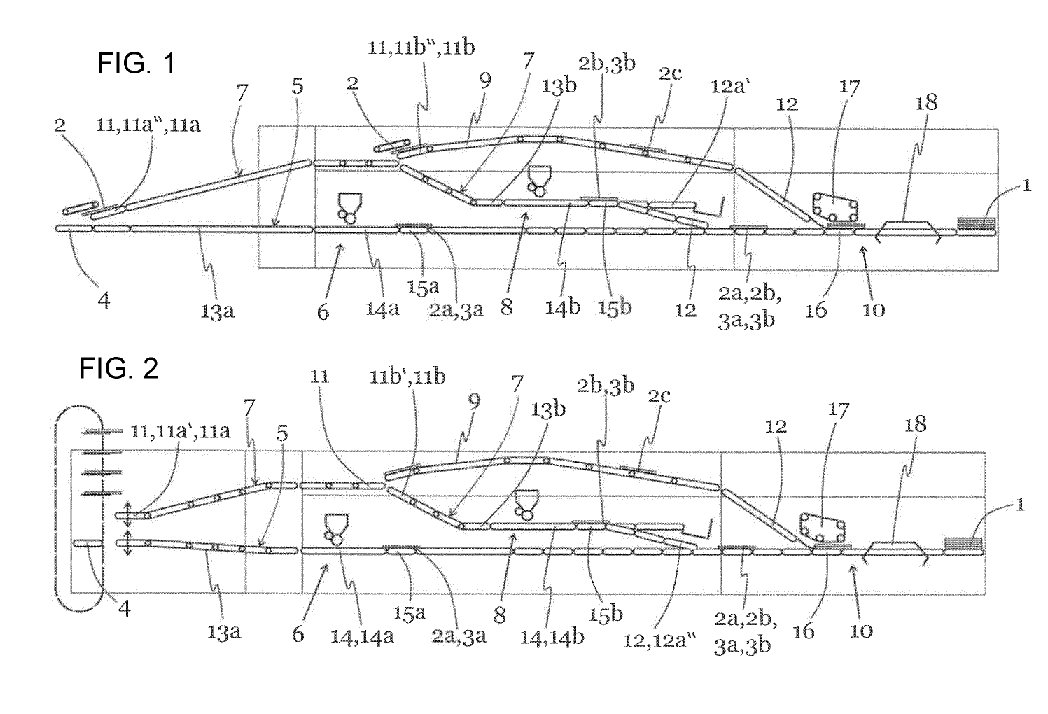

FIG. 1 shows a schematic side view of a system according to the invention in a first embodiment.

FIG. 2 shows a schematic side view of a system according to the invention in a second embodiment.

FIGS. 1 and 2 each show a system according to the invention for producing wafer blocks. These systems comprise an input station 4 at which the wafer sheets coming from a wafer baking machine are transferred to the system according to the invention. An input switch arrangement 11 is disposed in the transport direction downstream of the input station 4 or in the input station 4. In the present embodiment the input switch arrangement 11 comprises a plurality of switches, in particular a first input switch 11a and a second input switch 11b. The input switch arrangement 11 optionally has a first position 11a′. In this position wafer sheets coming from the input station 4 are transported along the first conveying surface 5 further in the direction of the first coating station 6. Furthermore, the input switch arrangement 11 can have a position 11a″. In this position wafer sheets 2 coming from the input station 4 are transferred to the second conveying surface 7. Furthermore, the input switch arrangement has another position 11b′ in which wafer sheets coming from the input station 4 and in particular coming from the second conveying surface 7 are conveyed along the second conveying surface 7 further in the direction of the second coating station 8. The input switch arrangement 11 also has another position 11b″ in which wafer sheets coming from the input station and in particular from the second conveying surface 7 are transferred to the third conveying surface 9. In the present embodiments of FIG. 1 and FIG. 2, a first input switch 11a and a second input switch 11b are provided in each case. The input switch 11a has two positions which correspond to the positions 11a′ and 11a″ of the preceding description. The second input switch 11b also has two positions 11b′ and 11b″ which correspond to the preceding description.

However, it is also consistent with the inventive idea that a single switch, for example a three-way switch allows the division between three conveying surfaces. Furthermore, it is also consistent with the inventive idea that the input switch arrangement deflects the wafer sheets, for example by means of an air flow or other means from one conveying surface onto another conveying surface.

For example, the input switches 11a and 11b can be designed as pivotable conveying devices. For example, a pivotable endless conveyor can be provided. The pivot axis of the nose in this case substantially corresponds to a horizontal axis which runs normally to the conveying direction and to the conveying surface of the wafers. The nose is preferably directed towards the conveying direction of the wafer sheets and is displaceable.

A wafer sheet 2 which is transported along the first conveying surface 5 passes a first feed conveyor device 13a in a first region. This feed conveyor device comprises one or more conveyor devices. A first wafer sheet is guided by the feed conveyor device to the first coating station 6. The first coating station 6 comprises a coating head by means of which the cream can be applied to a wafer sheet. Furthermore, the first coating station 6 comprises a coating conveyor device 14 and in particular a first coating conveyor device 14a. Optionally a plurality of coating devices are provided in the region of the coating station.

After the first coating conveyor device 14a, the wafer sheets 2 are conveyed further by means of a removal conveyor device 15. This removal conveyor device can also comprise a plurality of conveyor devices. The wafer sheets are conveyed further to the stacking station 10 by the removal conveyor device 15. The stacking station 10 for example comprises a sandwiching device 17 as well as a stacking device 18. One or more stack conveyor device(s) 16 is/are provided, for example, in the region of the stacking station 10.

When a wafer sheet 2 is moved along the second conveying surface 7, in a first step it passes the second feed conveyor device 13b. Like all the conveyor devices, this can be configured as a single conveyor device or as an arrangement of several conveyor devices. The feed conveyor device 13 transports the wafer sheet 2 along the second conveying surface 7 to the second coating station 8. The second coating station 8 again comprises a coating head. The second coating station 8 further comprises a second coating conveyor device 14b. After passing the second coating station 8, the coated wafer sheets are transported further by means of a second removal conveyor device 15b. This removal conveyor device 15b transports the wafer sheets further in the direction of the stacking station 10.

When a wafer sheet is conveyed along the third conveying surface 9, the third wafer sheet according to the present embodiment is not coated but arrives uncoated at the stacking station 10. In the stacking station 10, the third wafer sheet is for example placed on a first wafer sheet with a first cream layer or on a second wafer sheet with a second cream layer to form a wafer sandwich.

This wafer sandwich can then be raised, for example, by the stacking device 18 from the conveying surface and in particular by the stack conveyor device 16 in order to be able to convey a further wafer block component, in particular a first wafer sheet with a first cream layer or a second wafer sheet with a second cream layer into the stacking device 18. In a further step, the raised wafer sandwich is placed onto the cream layer of the further wafer sheet and pressed thereon. A stacking is thus achieved. In a further step the combination of three wafer sheets and two cream layers can be raised a further time in order to be pressed subsequently onto a further wafer sheet with a further cream layer. By pressing down the wafer block components stacked by the stacking device, a calibration of the wafer block is achieved. As a result, the wafer block can be calibrated to a constant and/or selectable height. Preferably the stack conveyor device is not arranged as a conventional, substantially elastic to non-rigid belt conveyor. For support against the calibrating force and against the pressure of the stacking device, a suction belt conveyor with a supported conveyor belt can for example be provided. Furthermore, a counterholder can be provided which is guided immediately below the belt of the stack conveyor device 16.

Preferably the system is configured in such a manner that the first conveying surface and the second conveying surface are connected or can be connected upstream of the stacking station by means of the output switch arrangement and in particular by means of the first output switch. As a result, the first wafer sheets and the second wafer sheets can be supplied successively to the stacking station in the desired number and sequence, in particular by means of the stack conveyor device.

Optionally the system is configured in such a manner that the third conveying surface is connected or can be connected to the stack conveying device by means of the output switch arrangement in the stacking station. As a result, the third wafer sheets can be joined directly in the stacking station and in particular in the sandwiching device to a first wafer sheet or to a second wafer sheet to form a wafer sandwich. In this case, the output switch arrangement extends to a part of the stacking station.

According to the invention, the system is suitable and/or adapted to form wafer blocks having an arbitrary number and sequence of different wafer block components. As an example, the production of a wafer block having the following layer structure from top to bottom is described:
a wafer sheet (wafer cover sheet)
a cream layer of a first cream (dark chocolate cream)
a wafer sheet
a cream layer of a second cream (light chocolate cream)
a wafer sheet
a cream layer of a first cream (dark chocolate cream)
a wafer sheet (wafer base sheet)

In order to produce this wafer block structure, the method according to the invention or the system according to the invention can be executed, for example, as follows:

In principle, four wafer sheets are required to form this wafer block. These wafer sheets are transferred successively by the wafer baking machine to the input station 4, where the sequence of the transfer need not necessarily correspond to the sequence of the layers of the finished wafer block. A wafer sheet is transferred by means of the input switch arrangement and in particular by means of the first input switch and the second input switch to the third conveying surface 9.

The next wafer sheet coming from the input station 4 is, for example, transferred by means of the input switch arrangement to the first conveying surface 5. In the course of the first conveying surface, the first wafer sheet 2a passes a feed conveyor device 13a and the first coating station 6. In the first coating station 6 the first wafer sheet 2a is provided with a first cream layer 3a of a first cream. The first cream in the present case is the dark chocolate cream.

The next wafer sheet 2 coming from the input station 4 is transferred as second wafer sheet 2b to the second conveying surface 7. There the second wafer sheet 2b is provided with a second cream layer 3b. The second cream layer 3b consists of a second cream which in the present case is a light chocolate cream.

The next sheet coming from the input station 4 is again, for example, supplied to the first conveying surface 5 in order to be coated with a first cream layer 3a of a first cream comprising dark chocolate.

The coating processes of the different conveying surfaces can take place simultaneously or consecutively.

The wafer sheets with their cream layers are conveyed further by means of the removal conveying devices. Firstly a first wafer sheet 2a with the first cream layer 3a is conveyed to the stacking station 10 by means of the first removal conveyor device 15a. At the same time, the third wafer sheet 2c is transported by means of the third conveying surface 9 and synchronized in such a manner that the third wafer sheet 2c and the first wafer sheet 2a are positioned substantially congruently above one another and joined together in the sandwiching device 17 of the stacking station 10. The stack conveyor device 16 conveys this wafer sandwich further to the stacking device 18. The stacking device 18 raises the wafer sandwich just formed from the stack conveyor device 16. Subsequently or simultaneously the second wafer sheet 2b with a second cream layer 3b of a second cream comprising light chocolate is supplied to the stacking station 10 by the second conveying surface 7. When this wafer block component is located in the stacking device 18, the wafer sandwich is pressed onto the second wafer sheet 2b with its second cream layer 3b and pressed thereon. At the same time or subsequently the combination of the wafer sandwich and the second wafer sheet with the second cream layer is again raised from the stack conveyor device. A further first wafer sheet 2a with a further first cream layer 3a is conveyed into the stacking station 10. There the raised combination of the wafer sandwich and the second wafer sheet is placed on the further first wafer sheet and in particular on the first cream layer 3a of the further first wafer sheet and pressed thereon so that the desired layer structure is formed. The wafer block is optionally calibrated a further time and compressed to a standard dimension. Subsequently the finished wafer block is conveyed from the stacking station 10 by means of the stack conveyor device 16.

The supply of the wafer block components from the first conveying surface 5, the second conveying surface 7 and the third conveying surface 9 is accomplished by means of an output switch arrangement 12. This output switch arrangement 12 can comprise a plurality of output switches, in particular a first output switch 12a and a second output switch 12b. These optionally have several positions by means of which the wafer sheets which are optionally coated with a cream can be supplied to the stacking station 10.

The output switch arrangement can, for example, comprise pivotable conveying devices, pivotable plates, rigid conveying devices, rigid plates or similar devices. Optionally, as in the input switch arrangement, a three-way switch is also provided.

Preferably a pivotable element of the output switch arrangement comprises a nose. This nose is preferably directed in the conveying direction of the wafer sheets. Optionally however the output switch arrangement or the output switch is also configured to be rigid. In this case, the conveying surfaces can run towards one another at an inclination so that it is possible to transfer the wafer sheets. Guide devices such as guide plates can also be used in order to transport the wafer sheets of the three conveying surfaces to the stacking station and in particular onto the stack conveying device.

In order to be able to stack the wafer block components in the stacking station 10 exactly above one another, an exact temporal control of the supply and position of the individual wafer block components is of major importance. For the controllability or adjustability of the positioning of the individual wafer block components, the system according to the invention preferably comprises a plurality of conveying devices. These conveying devices are configured, for example, as endless conveying devices. Preferably the individual conveying devices or at least some of the conveying device can be controlled or regulated separately from one another so that the speeds, in particular the transporting speeds of the wafer sheets moved on the conveying devices can be controlled individually. Sensors can also be provided in order, for example, to be able to determine the positions and/or the speeds of the individual wafer block components. In order to form a wafer sandwich, a sensor can be provided, for example, along the removal conveyor device of the third conveying surface 9. This detects the position of a third wafer sheet. Optionally the third wafer sheet can be stopped or slowed in order to only then be guided in the direction of the stacking station when the wafer base sheet with the cream layer is moved to the provided position. The position of the wafer base sheet can also be determined by a sensor such as a light curtain, for example.

In order to improve the efficiency of the coating station, the wafer sheets which are moved consecutively along the first conveying surface 5 or along the second conveying surface 7 into the coating station, are arranged edge to edge so that a continuous substantially interruption-free coatable surface is formed. After the coating station, the individual wafer sheets can again be separated from one another. This separation is accomplished, for example, by an acceleration of the coated wafer sheets. As a result of the speed difference, the wafer sheets are conveyed further at a distance from one another. This spacing is particularly advantageous when, for example, a second wafer sheet is to be inserted between two first wafer sheets in order to bring about an alternating stacking in the stacking station. Furthermore, a certain distance between the wafer sheets is also advantageous when the stacking station is adapted or suitable for stacking wafer block components which are supplied spaced apart from one another.

Furthermore an individual control of individual conveying devices is advantageous when the fraction of first wafer sheets in the finished wafer block is different from the fraction of the second wafer sheets. For example, in the preceding exemplary embodiment of the wafer block only one second wafer sheet is provided whereas two first wafer sheets are provided. Consequently, in order to form a plurality of wafer blocks 1 but also to form a single wafer block 1, twice as many first wafer sheets are coated with a first cream layer than second wafer sheets with a second cream layer. For this reason the throughput along the first conveying surface in this example is twice as high as the throughput at the second conveying surface. Consequently, the average speed along the first conveying surface should be about twice as high as the transporting speed of the second conveying surface. Consequently the ratio of the throughput of the first conveying surface to the throughput of the second conveying surface substantially corresponds to the ratio of the number of first wafer sheets to the number of second wafer sheets in the finished wafer block.

Due to different transporting speeds of individual conveying devices, buffer zones can also be formed in which wafer sheets already lie in order to be transported further as required.

According to a preferred embodiment of the invention a control unit is provided. This control unit is adapted and/or suitable for controlling or regulating parameters of the system and for modifying the parameters as a function of input selected parameters. For example, the desired layer structure of the finished wafer block can be input via the control unit or to the control unit. In this case, both the sequence and also the number of the individual wafer block components can be selected substantially freely. According to input, the transporting speeds and the coating speeds of the conveying devices are adapted so that the desired structure of the wafer block can be formed in the stacking station. According to preferred embodiments, the system is suitable for forming wafer blocks with three, four, five, six, seven, eight, nine and/or ten wafer sheets stacked one above the other.

### REFERENCE LIST

1 Wafer block
2 Wafer sheet
2a First wafer sheet
2b Second wafer sheet
2c Third wafer sheet
3 Cream layer
3a First cream layer
3b Second cream layer
4 Input station
5 First conveying surface
6 First coating station
7 Second conveying surface
8 Second coating station
9 Third conveying surface
10 Stacking station
11 Input switch arrangement
11a′ First position
11a″ Second position
11b′ First position
11b″ Second position
12 Output switch arrangement
12a′ First position
12a″ Second position
12b′ First position
12b″ Second position
13 Feed conveyor device
13a First feed conveyor device
13b Second feed conveyor device
14 Coating conveyor device
14a First coating conveyor device
14b Second coating conveyor device
15 Removal conveyor device
15a First removal conveyor device
15b Second removal conveyor device
16 Stack conveyor device
17 Sandwiching device
18 Stacking device

1-29. (canceled)

30. A system for forming wafer blocks, the wafer blocks having at least three wafer sheets and at least two cream layers of mutually different creams, and the wafer sheets and the cream layers lying alternately and parallel upon one another, the system comprising:
an input station at which individual wafer sheets are transferred successively to the system;
a first conveying surface for transporting first wafer sheets and a first coating station disposed for applying a first cream layer of a first cream to the first wafer sheets in the course of the first conveying surface;
a second conveying surface for transporting second wafer sheets and a second coating station disposed for applying a second cream layer of a second cream to the second wafer sheets in the course of the second conveying surface;
a third conveying surface for transporting third wafer sheets;
a stacking station at which the first wafer sheets with the first cream layers, the second wafer sheets with the second cream layers and the third wafer sheets are stacked to form one or more wafer blocks;
an input switch arrangement configured to selectively transfer the wafer sheets from the input station to the first conveying surface, to the second conveying surface or to the third conveying surface; and
an output switch arrangement configured to selectively transfer the wafer sheets of the first conveying surface, the second conveying surface or the third conveying surface to said stacking station.

31. The system according to claim 30, wherein:
the first conveying surface, the second conveying surface and the third conveying surface are disposed at a distance from one another, adjacent to one another and/or above one another;
the first conveying surface, the second conveying surface and the third conveying surface are connectable to one another by the input switch arrangement and the output switch arrangement so that a wafer sheet coming from the input station can be transported as desired via the first conveying surface, the second conveying surface or the third conveying surface to the stacking station.

32. The system according to claim 30, which comprises:
in the course of the first conveying surface, a first feed conveyor device for transporting the first wafer sheets to the first coating station, said first feed conveyor device being disposed upstream of the first coating station in a first conveying direction;
in the course of the first conveying surface along the first conveying direction, a first coating conveyor device being disposed in the region of the first coating station for transporting the first wafer sheets in the first coating station;
in the course of the first conveying surface along the first conveying direction, a first removal conveyor device being disposed downstream of the first coating station for transporting the first wafer sheets and the first cream layer applied thereon from the first coating station to the stacking station;
wherein a transporting speed of the first coating conveyor device is lower than a transporting speed of the first feed conveyor device and/or is lower than a transporting speed of the first removal conveyor device;
whereupon the first wafer sheets transported consecutively on the first conveying surface have a shorter spacing distance from one another in the region of the first coating station than in a course of the first conveying surface upstream and/or downstream of the first coating station.

33. The system according to claim 30, which comprises:
in the course of the second conveying surface, a second feed conveyor device for transporting the second wafer sheets to the second coating station disposed upstream of the second coating station in a second conveying direction;
in the course of the second conveying surface along the second conveying direction, a second coating conveyor device for transporting the second wafer sheets in the second coating station being disposed in the region of the second coating station;
in the course of the second conveying surface along the second conveying direction, a second removal conveyor device for transporting the second wafer sheets and the second cream layer applied thereon from the second coating station to the stacking station being disposed downstream of the second coating station;
wherein a transporting speed of the second coating conveyor device is lower than a transporting speed of the second feed conveyor device and/or is lower than a transporting speed of the second removal conveyor device;
whereupon the second wafer sheets transported consecutively on the second conveying surface have a shorter spacing distance from one another in the region of the second coating station than in a course of the second conveying surface upstream and/or downstream of the second coating station.

34. The system according to claim 32, wherein a speed difference between the transporting speed of said feed conveyor device minus a transporting speed of the coating conveyor device substantially corresponds to a value of the spacing distance between two wafer sheets conveyed consecutively on the feed conveyor device;
so that the wafer sheets in the coating station lie substantially edge to edge and form a continuous, spacing-free coatable surface.

35. The system according to claim 32, wherein a speed difference between a transporting speed in the region of the removal conveyor device minus a transporting speed in the region of the coating conveyor device substantially corresponds to a value of the spacing distance between two wafer sheets conveyed consecutively on the removal conveyor device;
so that the wafer sheets, which in the coating station lie substantially edge to edge and form a continuous, spacing-free coatable surface, are spaced from one another at a spacing distance in the region of the removal conveyor device in order to be conveyed at a spacing distance from one another into the stacking station.

36. The system according to claim 32, which comprises a stack conveyor device disposed at the stacking station and wherein a speed difference between the transporting speed in the region of the stack conveyor device minus the transporting speed in the region of the coating conveyor device substantially corresponds to a value of the distance between two wafer sheets conveyed consecutively on the stack conveyor device and coming from the conveying surface.

37. The system according to claim 32, wherein a distance between two respective wafer sheets conveyed consecutively on the removal conveyor device is greater than a dimension of a wafer sheet in the conveying direction;
enabling the output switch arrangement to position a second wafer sheet of the second conveying surface between two first wafer sheets of the first conveying surface; or
enabling the output switch arrangement to position a first wafer sheet of the first conveying surface between two second wafer sheets of the second conveying surface.

38. The system according to claim 30, wherein:
the input station, the stacking station and the coating stations are configured to transport the wafer sheets continuously; and
the coated wafer sheets are transported along the respective conveying surface arranged linearly in a row.

39. The system according to claim 30, wherein a transporting speed of the stack conveyor device is greater than a transporting speed of the coating conveyor device and is greater than or equal to or as the sum of the average transporting speeds of the first conveying surface plus the transporting speeds of the second conveying surface plus the transporting speeds of a third conveying surface, causing the wafer sheets to be conveyed into the stacking station at a spacing distance from one another.

40. The system according to claim 30, wherein the feed conveyor device, the coating conveyor device, the removal conveyor device and/or the stack conveyor device comprise devices selected from the group consisting of band conveyors, belt conveyors, and suction belt conveyors.

41. The system according to claim 30, wherein the input switch arrangement and/or the output switch arrangement comprise a switch arrangement selected from the group consisting of a pivotable plate, a pivotable band conveyor, a pivotable belt conveyor, a pivotable suction belt conveyor, conveying surfaces inclined with respect to one another and converging in or contrary to the conveying direction, an elevator, and a positive pressure source for changing a direction of movement and for raising the wafer sheets.

42. The system according to claim 30, wherein one or both of the input switch arrangement or the output switch arrangement is formed with a plurality of switch arrangements.

43. The system according to claim 30, which comprises a first input switch having:
a first position in which wafer sheets arriving from the input station are transferred to the first conveying surface; and
a second position in which wafer sheets arriving from the input station are conveyed to the second conveying surface.

44. The system according to claim 30, which comprises a second input switch having:
a first position in which wafer sheets arriving from the input station and/or from the first input switch are transported further along the second conveying surface; and
a second position in which wafer sheets arriving from the input station and/or from the first input switch are transferred to the third conveying surface.

45. The system according to claim 30, which comprises a first output switch having:
a first position in which first wafer sheets arriving from the first coating station are transferred to the stack conveyor device; and
a second position in which second wafer sheets arriving from the second coating station are transferred to the stack conveyor device.

46. The system according to claim 30, wherein the stacking station comprises a device selected from the group consisting of a spiral stacking device, a drop chute stacking device, and a combination of a sandwiching device and a stacking device.

47. The system according to claim 30, wherein said stacking station comprises a sandwiching device configured:
to cover a first wafer sheet coated with a first cream, or a second wafer sheet coated with a second cream with an uncoated third wafer sheet;
to form a wafer sandwich of a wafer base sheet, a wafer cover sheet and an interposed cream layer.

48. The system according to claim 30, which comprises a second output switch for transferring third wafer sheets arriving from a third conveying surface to the stack conveyor device and to transport the third wafer sheets directly into a sandwiching device in order to be combined therein with a first wafer sheet having a first cream layer or with a second wafer sheet having a second cream layer to form a wafer sandwich.

49. The system according to claim 30, wherein the stacking station comprises a stacking device configured to form a wafer sandwich by stacking at least one coated first wafer sheet and/or at least one coated second wafer sheet to thereby form a multilayer wafer block.

50. The system according to claim 49, wherein the stacking station comprises a calibrating device or a pressing device configured to compress the wafer blocks and components thereof to a predetermined height.

51. A method for forming a wafer block with three wafer sheets and at least two cream layers of mutually different creams, wherein the wafer sheets and the cream layers (3) are arranged alternately and parallel on one another, the method comprising the following steps:
specifying a desired number and a desired sequence of first wafer sheets each with a first cream layer of a first cream and second wafer sheets each with a second cream layer of a second cream;
conveying wafer sheets from an input station to an input switch arrangement;
selecting a position of the input switch arrangement so that wafer sheets are selectively transferred to the first conveying surface, to the second conveying surface or to the third conveying surface;
applying the first cream layer of a first cream to the first wafer sheet or to the first wafer sheets in the course of a first conveying surface;
applying the second cream layer of a second cream to the second wafer sheet or to the second wafer sheets in a course of a second conveying surface;
transporting a third wafer sheet along a third conveying surface;
transporting the first wafer sheets with the first cream layer, the second wafer sheets with the second cream layer and the third wafer sheets via an output switch arrangement to a stacking station;
thereby transferring to the stacking station the first wafer sheets or sheets with the first cream layer, the second wafer sheet or sheets with the second cream layer and the third wafer sheet consecutively and in a number and sequence corresponding to the desired number and the desired sequence.

52. The method according to claim 51, which comprises:
transporting wafer sheets along the course of the first conveying surface or along the second conveying surface consecutively via:
a feed conveyor device;
to a coating conveyor device;
and further to a removal conveyor device;
and thereby transporting the wafer sheets in the region of the coating conveyor device at a lower transporting speed than in the region of the feed conveyor device and/or in the region of the removal conveyor device so that the wafer sheets in each case in the region of the feed conveyor device and/or in the region of the removal conveyor device have a greater spacing distance from one another than in the region of the coating conveyor device.

53. The method according to claim 52, wherein a speed difference between the transporting speed in the region of the feed conveyor device minus the transporting speed in the region of the coating conveyor device substantially corresponds to a value of a dimension of the distance between two wafer sheets conveyed consecutively on the feed conveyor device;
so that the wafer sheets in the coating station lie substantially edge to edge and form a continuous, substantially spacing-free coatable surface.

54. The method according to claim 52, wherein a speed difference between the transporting speed in the region of the removal conveyor device minus the transporting speed in the region of the coating conveyor device substantially corresponds to a value of a dimension of the distance between two wafer sheets conveyed consecutively on the feed conveyor device;
so that the wafer sheets which lie in the coating station substantially edge to edge and form a continuous, spacing-free coatable surface, have a distance from one another in the region of the removal conveyor device in order to be conveyed spaced apart from one another into the stacking station.

55. The method according to claim 52, wherein a speed difference between the transporting speed in the region of the stack conveyor device minus the transporting speed in the region of the coating conveyor device substantially corresponds to a value of a dimension of the distance between two wafer sheets conveyed consecutively on the feed conveyor device and coming from a conveying surface.

56. The method according to claim 52, wherein the distance between two wafer sheets conveyed consecutively on the removal conveyor device is greater than a dimension of a wafer sheet in the conveying direction:
so that a second wafer sheet of the second conveying surface can be positioned between two first wafer sheets of the first conveying surface by means of the output switch arrangement; or
so that a first wafer sheet of the first conveying surface can be positioned between two wafer sheets of the second conveying surface.

57. The method according to claim 51, which comprises conveying the wafer sheets in the input station, the stacking station and the coating stations continuously and conveying the coated wafer sheets along the respective conveying surface arranged linearly in a row.

58. The method according to claim 51, which comprises forming a wafer block having x first wafer sheets and y second wafer sheets and a third wafer sheet so that the wafer block comprises x+y+1 wafer sheets and x+y cream layers, wherein x and y are integers.
